(19) United States
(12) Patent Application Publication
(10) Pub. No.: US 2024/0343243 A1
(43) Pub. Date: Oct. 17, 2024

(54) Actuating Apparatus for a Vehicle

(71) Applicant: Robert Bosch GmbH, Stuttgart (DE)

(72) Inventors: Florian Haag, Ellhofen (DE); Markus Schuster, Helmstadt (DE); Martin Marquart, Reichenbach (DE); Nikolas Loeffelmann, Dielheim (DE)

(21) Appl. No.: 18/602,578

(22) Filed: Mar. 12, 2024

(30) Foreign Application Priority Data
Apr. 14, 2023 (DE) 10 2023 203 410.7

(51) Int. Cl. B60T 17/22; B60K 26/02; B60T 7/04

(52) U.S. Cl. CPC B60T 17/22; B60K 26/02; B60T 7/042; B60T 2270/82; B60Y 2306/15

(57) ABSTRACT

An actuating apparatus for a vehicle, in particular a motor vehicle, includes (i) at least one first actuating surface for specifying a braking request, (ii) at least one second actuating surface for specifying an acceleration request, (iii) a first sensor unit for detecting an actuation of the first actuating surface, in particular an actuating force exerted on the first actuating surface, and (iv) a second sensor unit for detecting an actuation of the second actuating surface, in particular an actuating force exerted on the second actuating surface. At least one of the sensor units is provided for detecting an actuation of both actuating surfaces.

This application claims priority under 35 U.S.C. § 119 to patent application no. DE 10 2023 203 410.7, filed on Apr. 14, 2023 in Germany, the disclosure of which is incorporated herein by reference in its entirety.

### BACKGROUND

The disclosure relates to an actuating apparatus for a vehicle. The disclosure further relates to a vehicle pedal assembly comprising such an actuating apparatus, a drive-by-wire system comprising such a vehicle pedal assembly and a vehicle comprising such a drive-by-wire system. The disclosure also relates to a method for monitoring such an actuating apparatus.

Actuating apparatuses for vehicles, in particular traditional vehicle pedals, which are controlled by a foot or a pedal movement, are well-known. Novel drive-by-wire systems, which do not require a mechanical connection between the vehicle pedal and the drive or brake system and in which a driver input is transmitted exclusively electrically, are also known from the prior art, such as from DE 10 2017 117 154 A1. Due to the lack of mechanical coupling of the vehicle pedals to the drive and/or brake system, it is possible to design such vehicle pedals without travel or with a short stroke of a few millimeters. If this is the case, actuating apparatuses with force sensors are often used. A force sensor measures the foot or actuating force of the driver and forwards this information to a control unit or a plurality of control units in the vehicle. The force sensor can furthermore be mounted directly on an interior floor of the vehicle, which saves space in the vehicle interior and also provides the driver with a new feeling for controlling his vehicle.

The object of the disclosure is in particular to provide an actuating apparatus with improved properties with respect to detecting a driver input. This object is achieved by the features set forth below, while advantageous configurations and further developments of the disclosure can also be found below.

### SUMMARY

The disclosure relates to an actuating apparatus for a vehicle, in particular a motor vehicle, comprising at least one first actuating surface for specifying a braking request, comprising at least one second actuating surface for specifying an acceleration request which is in particular separate from the first actuating surface, comprising a first sensor unit for detecting an actuation of the first actuating surface, in particular an actuating force exerted on the first actuating surface, and comprising a second sensor unit for detecting an actuation of the second actuating surface, in particular an actuating force exerted on the second actuating surface.

It is proposed that at least one of the sensor units, in particular the first sensor unit and/or the second sensor unit, is provided for detecting an actuation of both actuating surfaces. Preferably, at least one of the sensor units is provided for detecting a first actuating force exerted on the first actuating surface and a second actuating force exerted on the second actuating surface. The at least one sensor unit could also be provided for simultaneously detecting actuation of both actuating surfaces. Preferably, however, the at least one sensor unit is provided for selectively detecting actuation of the actuating surfaces and/or for successively detecting actuation of the actuating surfaces. In this context, it is also conceivable, for example, to prioritize actuation of the second actuating surface or preferably the first actuating surface. This configuration can improve the detection of a driver input. This is in particular makes it possible to recognize a driver input correctly and increase operational reliability. The resulting synergy effects also make it possible to provide an advantageously cost-effective solution.

An “actuating apparatus” is intended to be understood as at least a part, for example a subassembly, of an operating unit, in particular one that can be actuated by a driver, advantageously a vehicle pedal assembly, and preferably an electric vehicle pedal assembly. The operating unit, in particular the vehicle pedal assembly, is preferably part of a drive-by-wire system. The sensor units are moreover in particular intended to provide a detection signal correlated with the actuation of the corresponding actuating surface and to transmit it electrically to at least one control unit of the vehicle, for example a brake control device of a brake system, drive control device of a drive system, a zone controller and/or a central vehicle control unit. For this purpose, the respective sensor unit can comprise at least one sensor, in particular a displacement sensor, a pressure sensor and/or preferably a force sensor. The term “provided” is in particular intended to be understood to mean specifically programmed, configured, and/or equipped. An object being provided for a specific function is in particular intended to be understood to mean that the object fulfills and/or carries out this specific function in at least one application and/or operating state.

According to a particularly preferred embodiment, it is proposed that the actuating apparatus comprises a third sensor unit, wherein the first sensor unit is assigned exclusively to the first actuating surface, the second sensor unit is assigned to both actuating surfaces, i.e. the first actuating surface and the second actuating surface, and the third sensor unit is assigned exclusively to the second actuating surface. In this case, the first sensor unit is thus provided exclusively for detecting an actuation of the first actuating surface and the third sensor unit exclusively for detecting an actuation of the second actuating surface. The first sensor unit can therefore be configured as a brake sensor and provided for detecting a braking request. The third sensor unit can also be configured as an acceleration sensor and provided for detecting an acceleration request. The second sensor unit is furthermore provided for detecting an actuation of the first actuating surface and for detecting an actuation of the second actuating surface, in particular simultaneously or selectively or successively. The third sensor unit can therefore be configured as a combination sensor and provided for detecting a braking request and/or acceleration request. The first sensor unit, the second sensor unit and/or the third sensor unit can moreover advantageously each be configured as a, preferably individual, force sensor. This in particular makes it possible to achieve especially high operational reliability and at the same time especially high cost efficiency.

It is further proposed that the second sensor unit be mechanically coupled to the first sensor unit and the third sensor unit. The second sensor unit therefore has a first direct mechanical connection to the first sensor unit. The second sensor unit also has a second direct mechanical connection to the third sensor unit. The first direct mechanical connection and the second direct mechanical connection are preferably separate and spaced apart from one another. The second sensor unit can thus advantageously be used to monitor the first sensor unit and the third sensor unit.

The second sensor unit could be positioned between the first actuating surface and the first sensor unit, for example, and/or between the second actuating surface and the third sensor unit. However, it is preferred that the second sensor unit is disposed on a side of the first sensor unit facing away from the first actuating surface and/or on a side of the third sensor unit facing away from the second actuating surface, which makes it possible to simplify signal evaluation and/or provide an advantageously robust actuating apparatus.

An advantageous control algorithm can furthermore be provided if, in a normal operating mode, a detection signal from the first sensor unit is provided or used for controlling a brake system, a detection signal from the third sensor unit is provided or used for controlling a drive system and a detection signal from the second sensor unit is provided or used for checking the plausibility of the detection signal from the first sensor unit and/or the detection signal from the third sensor unit.

It is further proposed that, in a first fault operating mode in which the second sensor unit has a fault, the detection signal from the first sensor unit is provided or used for controlling the brake system and the detection signal from the third sensor unit is provided or used for controlling the drive system and the plausibility check of the detection signal from the first sensor unit and/or the detection signal from the third sensor unit is omitted. This makes it possible to provide an advantageously redundant actuating apparatus, which is also functional in the event of a fault and/or failure of the second sensor unit.

It is further proposed that, in a second fault operating mode in which the first sensor unit has a fault, the detection signal from the second sensor unit is provided or used for controlling the brake system and/or, in a third fault operating mode in which the third sensor unit has a fault, the detection signal from the second sensor unit is provided or used for controlling the drive system. When using the second sensor unit to control the brake system or the drive system, the detection signal from the other functional sensor unit is advantageously subtracted from the detection signal from the second sensor unit. This makes it possible to provide an advantageously redundant actuating apparatus, which is also functional in the event of a fault and/or failure of the first or third sensor unit.

It is also preferably proposed that, in a fourth fault operating mode in which the first sensor unit and the third sensor unit, in particular simultaneously, have a fault, the detection signal from the second sensor unit is provided or used for controlling the brake system. In the event of failure of the first sensor unit, i.e. the brake sensor, and the third sensor unit, i.e. the acceleration sensor, the second sensor unit, i.e. the combination sensor, is therefore advantageously used to control the brake system, for example to initiate and/or carry out a safe stop. This makes it possible to achieve an advantageously redundancy and increase operational reliability.

Also proposed is a method for monitoring an actuating apparatus, in particular the aforementioned actuating apparatus, in which an actuation of a first actuating surface for specifying a braking request, in particular an actuating force exerted on the first actuating surface, is ascertained by means of a first sensor unit and an actuation of a second actuating surface for specifying an acceleration request, in particular an actuating force exerted on the second actuating surface, is ascertained by means of a second sensor unit, wherein an actuation of both actuating surfaces is ascertained by means of at least one of the sensor units and a corresponding detection signal is used at least in a normal operating mode to check the plausibility of a detection signal from the other sensor unit. In at least one fault operating mode, the corresponding detection signal can also be used to control a drive system and/or a brake system of the vehicle. Thus in particular the aforementioned advantages can be achieved. In particular a detection of a driver input can be improved.

It is also advantageously proposed that only an actuation of the first actuating surface is ascertained by means of the first sensor unit, an actuation of both actuating surfaces is ascertained by means of the second sensor unit and only an actuation of the second actuating surface is ascertained by means of a third sensor unit, and a fault allocation is carried out by comparing a detection signal from the first sensor unit, a detection signal from the second sensor unit and a detection signal from the third sensor unit. The fault allocation is therefore preferably carried out by comparing all three detection signals. This makes it possible to achieve a particularly advantageous fault allocation.

It is also proposed that, in a first step, the detection signal from the first sensor unit is compared with the detection signal from the second sensor unit, in a second step, the detection signal from the third sensor unit is compared with the detection signal from the second sensor unit and, in a third step, the fault allocation is carried out by evaluating and comparing the first comparison in the first step and the second comparison in the second step, wherein, in the event of a fault in the first comparison and a fault in the second comparison, the second sensor unit is classified as non-functional, in the event of a fault in the first comparison and a fault-free second comparison, the first sensor unit is classified as non-functional and, in the event of a fault-free first comparison and a fault in the second comparison, the third sensor unit is classified as non-functional. This in particular makes it possible to provide an advantageously efficient evaluation algorithm.

The actuating apparatus, the vehicle pedal assembly, the drive-by-wire system, the vehicle and the method for monitoring the actuating apparatus are not intended to be limited to the above-described application and embodiment. In order to carry out a function described here, the actuating apparatus, the vehicle pedal assembly, the drive-by-wire system, the vehicle and the method for monitoring the actuating apparatus can in particular comprise a number of individual elements, components and units that differs from a number specified here.

### BRIEF DESCRIPTION OF THE DRAWINGS

Further advantages will become apparent from the following description of the drawing.

The drawings show an embodiment example of the disclosure.

The figures show:

FIG. 1 a simplified illustration of a vehicle with an example vehicle pedal assembly comprising an actuating apparatus,

FIG. 2 a detailed illustration of the actuating apparatus and

FIG. 3 an example flowchart with main method steps of a method for monitoring the actuating apparatus.

### DETAILED DESCRIPTION

FIG. 1 shows a schematic illustration of an example of a vehicle 10 which is configured as a motor vehicle comprising a drive-by-wire system 28. The drive-by-wire system 28 includes a vehicle pedal assembly 26, which is in particular driver-actuatable and in the present case is configured electrically. The drive-by-wire system 28 also includes a brake system 22 that is mechanically separate from the vehicle pedal assembly 26, and a drive system 24 that is mechanically separate from the vehicle pedal assembly 26. In the present case, the vehicle pedal assembly 26 has a purely electrical connection to the brake system 22 and the drive system 24. In this case, the vehicle pedal assembly 26 can also be configured without travel or with a short stroke of a few millimeters. The vehicle pedal assembly could, however, alternatively also have a mechanical, hydraulic, and/or pneumatic connection to a drive and/or brake system. It is in principle also conceivable to use an operating unit other than a vehicle pedal assembly.

The vehicle pedal assembly 26 comprises an actuating apparatus. The actuating apparatus comprises a first actuating surface 12 for specifying a braking request and a second actuating surface 14 for specifying an acceleration request. The actuating surfaces 12, 14 are identically structured. In the present case, the actuating surfaces 12, 14 are provided for foot actuation by a driver. An actuating apparatus could in principle also comprise at least three actuating surfaces.

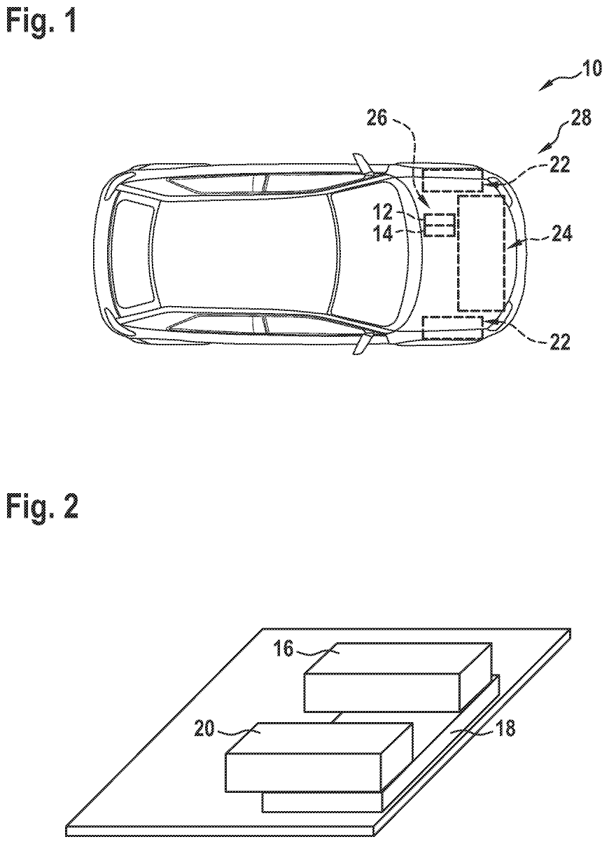

The actuating apparatus further comprises a plurality of sensor units 16, 18, 20 (see in particular FIG. 2). In the present case, the actuating apparatus comprises three sensor units 16, 18, 20, in particular a first sensor unit 16, a second sensor unit 18 and a third sensor unit 20. An actuating apparatus could in principle also comprise two sensor units or four sensor units. The actuating apparatus in the present case always comprises a number of sensor units 16, 18, 20 that is greater than a number of actuating surfaces 12, 14. The sensor units 16, 18, 20 are furthermore at least substantially identically structured.

The first sensor unit 16 is configured as a brake sensor and in the present case is assigned exclusively to the first actuating surface 12. The first sensor unit 16 is disposed directly underneath the first actuating surface 12. In the present case, the first sensor unit 16 is moreover configured as a single force sensor. The first sensor unit 16 is provided exclusively for detecting an actuation of the first actuating surface 12. In the present case, the first sensor unit 16 is provided for detecting a first actuating force exerted on the first actuating surface 12. The first sensor unit 16 therefore measures the first actuating force and passes this information on to at least one control unit (not shown) in the vehicle 10, for example a brake control device of the brake system 22. A first sensor unit could, however, alternatively also comprise a plurality of, in particular identically configured or different, sensors.

The third sensor unit 20 is configured as an acceleration sensor and in the present case is assigned exclusively to the second actuating surface 14. The third sensor unit 20 is disposed directly underneath the second actuating surface 14. In the present case, the third sensor unit 20 is moreover configured as a single force sensor. The third sensor unit 20 is provided exclusively for detecting an actuation of the second actuating surface 14. In the present case, the third sensor unit 20 is provided for detecting a second actuating force exerted on the second actuating surface 14. The third sensor unit 20 therefore measures the second actuating force and passes this information on to at least one further control unit (not shown) in the vehicle 10, for example a drive control device of the drive system 24. The further control unit and the control unit can in principle also be identical, i.e. form a single zone controller and/or central vehicle control unit. A third sensor unit could, however, alternatively also comprise a plurality of, in particular identically configured or different, sensors.

The second sensor unit 18 is configured as a combination sensor and in the present case is assigned to both actuating surfaces 12, 14. The second sensor unit 20 is therefore disposed underneath the first actuating surface 12 and underneath the second actuating surface 14. In the present case, the second sensor unit 18 is disposed on a side of the first sensor unit 16 facing away from the first actuating surface 12 and on a side of the third sensor unit 20 facing away from the second actuating surface 14. The second sensor unit 18 is furthermore mechanically coupled to the first sensor unit 16 and the third sensor unit 20. The second sensor unit 18 therefore has a first direct mechanical connection to the first sensor unit 16 and a second direct mechanical connection to the third sensor unit 20 which is separate and spaced apart from the first direct mechanical connection. The second sensor unit 18 is also configured as a single force sensor. The second sensor unit 18 is provided for detecting an actuation of the first actuating surface 12 and for detecting an actuation of the second actuating surface 14, in particular simultaneously or selectively or successively. In the present case, the second sensor unit 18 is provided for detecting an actuating force exerted on the first actuating surface 12 and/or the second actuating surface 14. Thus, at least the second sensor unit 18 is provided for detecting an actuation of both actuating surfaces 12, 14. In the present case, the second sensor unit 18 also has an electrical connection to the control unit and/or the further control unit.

In the present case, in a normal operating mode, a detection signal from the first sensor unit 16 is provided for controlling the brake system 22 and a detection signal from the third sensor unit 20 is provided for controlling the drive system 24, while a detection signal from the second sensor unit 18 is used to check the plausibility of the detection signal from the first sensor unit 16 and the detection signal from the third sensor unit 20.

Furthermore, in a first fault operating mode in which the second sensor unit 20 has a fault, the detection signal from the first sensor unit 16 is provided for controlling the brake system 22 and the detection signal from the third sensor unit 20 is provided for controlling the drive system 24. At the same time, a plausibility check is omitted, which makes it possible to provide an advantageously redundant actuating apparatus that is also functional in the event of a fault and/or failure of the second sensor unit 18.

In a second fault operating mode in which the first sensor unit 16 has a fault, on the other hand, the detection signal from the second sensor unit 18 is used for controlling the brake system 22. For this purpose, the detection signal from the functional third sensor unit 20 can be subtracted from the detection signal from the second sensor unit 18.

In a third fault operating mode in which the third sensor unit 20 has a fault, the detection signal from the second sensor unit 18 is used in the same way for controlling the drive system 24. For this purpose, the detection signal from the functional first sensor unit 16 can be subtracted from the detection signal from the second sensor unit 18, if necessary.

In addition, in a fourth fault operating mode in which the first sensor unit 16 and the third sensor unit 20 have a fault at the same time, the detection signal from the second sensor unit 18 is provided for controlling the brake system 22, as a result of which at least a safe stop can still be initiated and/or carried out.

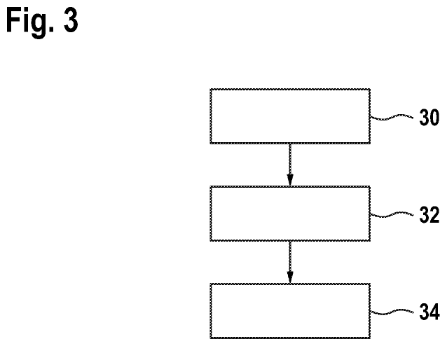

A fault allocation can moreover be carried out by comparing the detection signal from the first sensor unit 16, the detection signal from the second sensor unit 18 and the detection signal from the third sensor unit 20 (see in particular also FIG. 3, which shows the main method steps of a corresponding method for monitoring the actuating apparatus).

In a first method step 30, the detection signal from the first sensor unit 16 is compared with the detection signal from the second sensor unit 18.

In a second method step 32, the detection signal from the third sensor unit 20 is then compared to the detection signal from the second sensor unit 18.

Subsequently, in a third method step 34, the fault allocation is carried out by evaluating and comparing the first comparison in the first step and the second comparison in the second step.

If the first comparison is fault-free and the second comparison is fault-free, all of the sensor units 16, 18, 20 are classified as functional.

If there is a fault in the first comparison and a fault in the second comparison, the second sensor unit 18 is classified as non-functional.

If there is a fault in the first comparison and the second comparison is fault-free, the first sensor unit 16 is classified as non-functional.

If the first comparison is fault-free and there is a fault in the second comparison, the third sensor unit 20 is classified as non-functional.

The flowchart in FIG. 3 is intended to describe a method for monitoring an actuating apparatus merely as an example. Individual method steps can in particular also vary or additional method steps can be added.

What is claimed is:

1. An actuating apparatus for a vehicle, comprising:
at least one first actuating surface configured to specify a braking request;
at least one second actuating surface configured to specify an acceleration request;
a first sensor unit configured to detect an actuating force exerted on the first actuating surface, and
a second sensor unit configured to detect an actuating force exerted on the second actuating surface,
wherein at least one of the sensor units is configured to detect an actuation of both actuating surfaces.

2. The actuating apparatus according to claim 1, further comprising a third sensor unit, wherein:
the first sensor unit is assigned exclusively to the first actuating surface,
the second sensor unit is assigned to both actuating surfaces, and
the third sensor unit is assigned exclusively to the second actuating surface.

3. The actuating apparatus according to claim 2, wherein the second sensor unit is mechanically coupled to the first sensor unit and the third sensor unit.

4. The actuating apparatus according to claim 2, wherein the second sensor unit is disposed on a side of the first sensor unit facing away from the first actuating surface and/or on a side of the third sensor unit facing away from the second actuating surface.

5. The actuating apparatus according to claim 2, wherein, in a normal operating mode:
a detection signal from the first sensor unit is provided for controlling a brake system,
a detection signal from the third sensor unit is provided for controlling a drive system, and
a detection signal from the second sensor unit is provided for checking the plausibility of the detection signal from the first sensor unit and/or the detection signal from the third sensor unit.

6. The actuating apparatus according to claim 5, wherein, in a first fault operating mode in which the second sensor unit has a fault:
the detection signal from the first sensor unit is provided for controlling the brake system,
the detection signal from the third sensor unit is provided for controlling the drive system, and
the plausibility check of the detection signal from the first sensor unit and the detection signal from the third sensor unit is omitted.

7. The actuating apparatus according to claim 5, wherein:
in a second fault operating mode in which the first sensor unit has a fault, the detection signal from the second sensor unit is provided for controlling the brake system, and/or
in a third fault operating mode in which the third sensor unit has a fault, the detection signal from the second sensor unit is provided for controlling the drive system.

8. The actuating apparatus according to claim 7, wherein:
in a fourth fault operating mode in which the first sensor unit and the third sensor unit have a fault, the detection signal from the second sensor unit is provided for controlling the brake system.

9. A vehicle pedal assembly comprising at least one actuating apparatus according to claim 1.

10. A drive-by-wire system comprising at least one vehicle pedal assembly according to claim 9.

11. A motor vehicle, comprising a drive-by-wire system according to claim 10.

12. A method for monitoring an actuating apparatus according to claim 1, wherein:
an actuation of a first actuating surface for specifying a braking request, including an actuating force exerted on the first actuating surface, is ascertained by way of a first sensor unit,
an actuation of a second actuating surface for specifying an acceleration request, including an actuating force exerted on the second actuating surface, is ascertained by way of a second sensor unit, and
an actuation of both actuating surfaces is ascertained by way of at least one of the sensor units and a corresponding detection signal is used at least in a normal operating mode to check the plausibility of a detection signal from the other sensor unit.

13. The method according to claim 12, wherein:
only an actuation of the first actuating surface is ascertained by way of the first sensor unit,
an actuation of both actuating surfaces is ascertained by way of the second sensor unit,
only an actuation of the second actuating surface is ascertained by way of a third sensor unit, and
a fault allocation is carried out by comparing a detection signal from the first sensor unit, a detection signal from the second sensor unit, and a detection signal from the third sensor unit.

14. The method according to claim 13, wherein:
in a first step, the detection signal from the first sensor unit is compared with the detection signal from the second sensor unit,
in a second step, the detection signal from the third sensor unit is compared with the detection signal from the second sensor unit,
in a third step, the fault allocation is carried out by evaluating and comparing the first comparison in the first step and the second comparison in the second step,
in the event of a fault in the first comparison and a fault in the second comparison, the second sensor unit is classified as non-functional,
in the event of a fault in the first comparison and a fault-free second comparison, the first sensor unit is classified as non-functional, and
in the event of a fault-free first comparison and a fault in the second comparison, the third sensor unit is classified as non-functional.

15. The actuating apparatus according to claim 1, wherein the vehicle is a motor vehicle.
